(19) United States
(12) Patent Application Publication
(10) Pub. No.: US 2026/0131712 A1
(43) Pub. Date: May 14, 2026

(54) ADAPTIVE BLADDER LOCATION

(71) Applicant: LEAR CORPORATION, Southfield, MI (US)

(72) Inventors: Samuel Blair, Rochester, MI (US); David Abdella, Farmington, MI (US)

(21) Appl. No.: 19/041,283

(22) Filed: Jan. 30, 2025

Related U.S. Application Data
(60) Provisional application No. 63/719,797, filed on Nov. 13, 2024.

(51) Int. Cl. B60N 2/90

(52) U.S. Cl. CPC B60N 2/914

(57) ABSTRACT

A seat system includes a bladder assembly that comprises a carrier substrate and inflatable bladders attached with the carrier substrate. Each of the inflatable bladders is fluidly connected with an associated feed channel. The carrier substrate comprises at least one group of configurable bladder locations. At least one of the inflatable bladders is a foldable bladder that is foldable from an unfolded position into a folded position selected from the group of configurable bladder locations and at which the foldable bladder is secured to the carrier substrate.

### BACKGROUND

Automobile seats may include a massage assembly that has inflatable cells or bladders. The bladders are connected via fluid supply lines to a valve arrangement. A pump provides air to the valve arrangement, which directs the air to the bladders to be inflated. The bladders may be inflated and deflated in a sequence to provide a desired massage effect to the seat occupant.

### BRIEF DESCRIPTION OF THE DRAWINGS

The various features and advantages of the present disclosure will become apparent to those skilled in the art from the following detailed description. In this disclosure, like reference numerals designate like elements where appropriate and reference numerals with the addition of one-hundred or multiples thereof designate modified elements that are understood to incorporate the same features and benefits of the corresponding elements. The drawings that accompany the detailed description can be briefly described as follows.

FIG. 1 illustrates a seat system.

FIG. 2 illustrates an inflatable bladder assembly.

FIG. 3 illustrates an inflatable bladder assembly with foldable bladders that are in unfolded positions.

FIG. 4 illustrates the inflatable bladder assembly with foldable bladders in a folded positions.

FIG. 5 illustrates a feed tube that is reinforced with internal protrusions.

FIG. 6 illustrates another example feed tube that is reinforced with internal protrusions.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

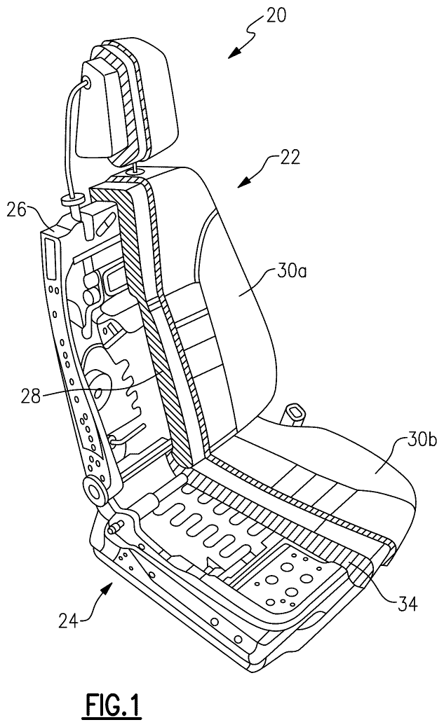

FIG. 1 illustrates an example seat system 20 for an automobile. In this example, the seat 20 system includes a seat back 22 and a seat base 24. A seat frame 26 supports a cushion 28 in the seat back 22, which is covered by trim 30a. In the seat base 24, the frame 26 supports a bottom seat cushion 34, which is covered by seat trim 30b. Although the example seat system 20 is for an automobile, it is to be understood that the examples are applicable to other types of vehicles, such as but not limited to, a motorcycle, a watercraft, an aircraft, or a locomotive.

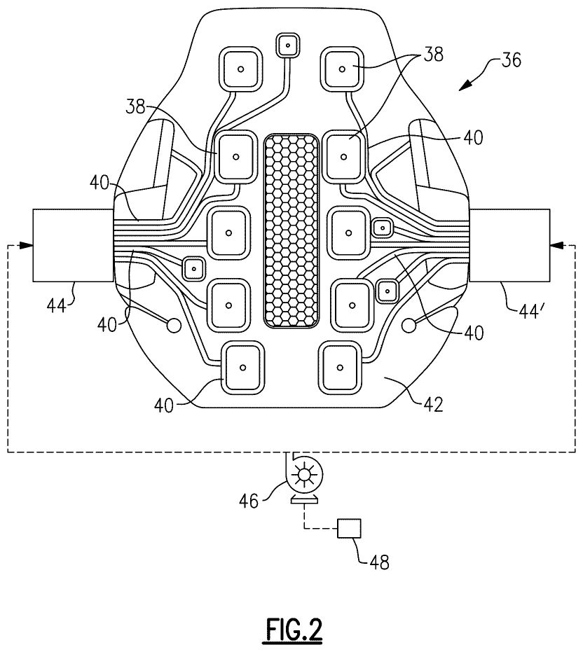

FIG. 2 illustrates selected portions of an inflatable bladder assembly 36 for incorporation into the seat system 20. The inflatable bladder assembly 36 includes a plurality of inflatable bladders 38 and air channels 40 in fluid communication with the bladders 38 for inflating and deflating the bladders 38. The bladders 38 are formed from polymer films (e.g., thermoplastic urethane) that are welded together to form expandable cells. The bladders 38 are attached with one or more polymer film carrier substrates 42.

The channels 40 fluidly connected with one or more valve banks 44. The valve banks 44 are fluidly connected with one or more pumps 46. A processor 48 is connected with the pump 46, to control operation thereof. The processor 48 may also be connected with the valve banks 44 to open and close the valves of the banks 44 to selectively provide air to the bladders 38 via the channels 40. The channels 40 are embedded in the carrier substrate 42. For example, two adjacent polymer film layers of the carrier substrate 42 are welded together along two paths from the location of the valve banks 44 to the location of the bladders 38. The region between the weld paths is not welded and there is thus an air passage defined between the polymer film layers and the weld paths.

The inflatable bladder assembly 36 provides a patterned arrangement of the bladders 38. For instance, in the illustrated example the bladders 38 are configured in two vertical columns. In other examples, the bladders 38 may be staggered in the columns and/or spaced apart from each other in different spacing intervals, depending on the desired configuration for massage and support effects in a given seat design. However, different seat designs may require different bladder configurations, and each seat design may thus require a different bladder assembly design. In this regard, as will be discussed in more detail in the following examples, the inflatable bladder assembly 36 is configurable to multiple different bladder patterns. As a result, a single design of the inflatable bladder assembly 36 may be used across multiple different seat designs that would otherwise require multiple different bladder assembly designs.

FIG. 3 illustrates an example of the reconfigurability of an inflatable bladder assembly 136. The inflatable bladders assembly 136 includes one ore more foldable bladders. In this example, the inflatable bladders assembly 136 includes two foldable bladders, which are designated as 38a and 38b, while the bladders 38 are non-foldable. As used herein, the term “foldable” refers to the ability of a bladder to be bent about a fold line over onto the carrier substrate 42 and, once folded, the bladder is securable in the folded position and is functional for inflation and deflation without impeding functionality of any other bladder for inflation and deflation. Additionally, the fold line is non-intersecting with the bladder (i.e., the fold is not through the bladder). By contrast, a “non-foldable” bladder might be capable of being folded, but it is not securable once folded and the folding may impede inflation and deflation of at least one other bladder.

The foldable bladders 38a/38b are disposed on respective flaps 50. The flaps 50 are attached with the carrier substrate 42 along a fold lines 52, while lateral edges 52a/52b of the flap 50 are severed from the carrier substrate 42, thus freeing the flaps 50 to fold about the respective fold lines 52. Opposite the foldable bladder 38a, the carrier substrate 42 includes a group (two or more) of configurable bladder locations 54a/54b, and opposite the foldable bladder 38b the carrier substrate 42 includes another group of configurable bladder locations 56a/56b. The bladder locations 54a/54b/56a/56b represent locations at which the respective foldable bladders 38a/38b can be folded to and secured to provide a final bladder configuration of the inflatable bladder assembly 136. Thus, each of the bladder locations 54a/54b/56a/56b provides a unique pattern of the bladders on the carrier substrate 42. For example, each bladder location 54a/54b/56a/56b is demarked by a fastener 58 a. There is a corresponding fastener 58 b on the foldable bladders 38a/38b that is securable with the fastener 58 a to hold the foldable bladder 38a/38b in the folded position at the location 54a/54b/56a/56b.

To configure the inflatable bladder assembly 136, a user chooses which bladder locations 54a/54b/56a/56b are to be used to achieve a desired final bladder configuration. The user then lifts and folds the flaps 50 about the fold lines 52. The bladder 38a is folded toward whichever location 54a or 54b is desired, and the bladder 38b is folded toward whichever location 56a or 56b is desired. Once folded, the fasteners 58b are secured with fasteners 58 a. The securing of the fasteners 58a/58b holds the bladders 38a/38b in the folded position. FIG. 4 illustrates the inflatable bladder assembly 136 with the bladders 38a/38b secured in the folded positions at locations 54a and 56b, respectively. Once secured, the inflatable bladders assembly 136 may be installed into the seat system 20. As will be appreciated given this disclosure, a foldable bladder may have more than two bladder locations to which it is securable, as long as it can reach the locations without substantially sacrificing inflation and deflation performance, once folded. The process of folding and securing the bladders 38a/38b may be conducted manually, by automation, or by a combination of automation and manual assembling.

As an example, the fasteners 58a/58b are mating halves of a snap that are securable by pressing one into the other. As will be appreciated given this disclosure, the examples are not limited to snaps, and other types of mechanical fasteners may alternatively or additionally be used, such as but not limited to, hooks and loops or clamps. In further examples, an adhesive may be used in addition to or instead of the fasteners 58a/58b. In yet another example, the bladders 38a/38b may be welded to the carrier substrate 42 after being folded to form a weld joint that secured the bladders 38a/38b in the folded position, such as by laser welding or high frequency welding. Welding, however, may require additional tooling, and mechanical fastening may thus facilitate a more efficient process.

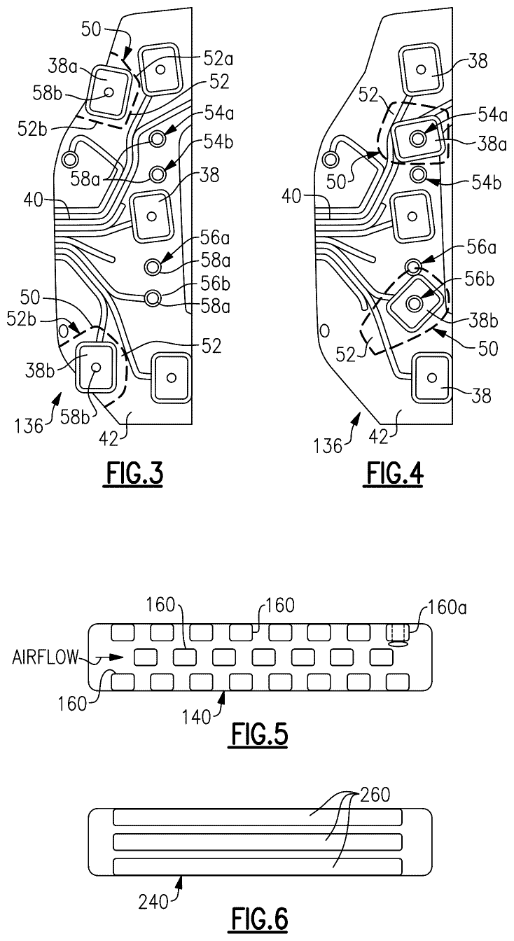

The air channels 40 to the foldable bladders 38a/38b are routed through the fold line 52 so as to avoid the severed lateral edges of the flaps 50. As a result, the channels 40 will also be folded. In some instances, the polymer film layers that form the channels 40 may be rigid enough to prevent full kinking of the channel 40, in which case air would be fully or substantially fully prevented flow through to reach the bladders 38a/38b. However, as shown in FIG. 5, a reinforced channel 140 may be used in order to prevent or limit kinking, and thus preserve full or substantially full air flow to the bladders 38a/38b, once folded. In this example, the reinforced channel 140 includes a plurality of protrusions 160 on the interior side walls of the channel. When the channel 140 is folded over onto itself, the protrusions 160 prevent the channel 140 from kinking closed. For instance, the protrusions 160 contact each other to brace the channel 140 and prevent the channel 140 from collapsing such that air can flow through. In the illustrated example, the protrusions 160 are raised dots that extend into the air flow passage in the channel 140, but the protrusions may alternatively be raised rings, shown at 160a. In general, the raised dots or raised rings have an aspect ratio of about 1, meaning they have equal dimensions in the length direction of the channel 140 and in the width direction of the channel 140 (perpendicular to the length direction).

FIG. 6 illustrates another example of a reinforced channel 240. In this example, the protrusions 260 are ribs that are elongated in the length direction of the channel 240. Similar to the protrusions 60, the protrusions 160 serve to prevent the channel 240 from kinking closed. In general, the ribs have an aspect ratio of greater than 1, such as an aspect ratio of 2, 3, 5, or 10, meaning they have a larger dimension in the length direction of the channel 140 than in the width direction of the channel 140 (perpendicular to the length direction). It is also to be appreciated that combinations of protrusions 60 and 160 may be used.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A seat system comprising:
a bladder assembly comprising a carrier substrate and inflatable bladders attached with the carrier substrate, each of the inflatable bladders fluidly connected with an associated feed channel, the carrier substrate comprising at least one group of configurable bladder locations, at least one of the inflatable bladders is a foldable bladder that is foldable from an unfolded position into a folded position selected from the group of configurable bladder locations and at which the foldable bladder is secured to the carrier substrate.

2. The seat system as recited in claim 1, wherein the foldable bladder is on a flap.

3. The seat system as recited in claim 2, wherein lateral edges of the flap are severed from the carrier substrate.

4. The seat system as recited in claim 1, wherein the foldable bladder comprises a fastener securing the foldable bladder to the carrier substrate in the folded position.

5. The seat system as recited in claim 4, wherein the fastener includes a snap.

6. The seat system as recited in claim 1, wherein the foldable bladder is foldable along a fold line, and the associated feed channel crosses the fold line.

7. The seat system as recited in claim 6, wherein the fold line is non-intersecting with the foldable bladder.

8. The seat system as recited in claim 6, wherein the feed channel includes internal protrusions.

9. The seat system as recited in claim 8, wherein the internal protrusions are selected from the group consisting of raised dots, raised rings, elongated ribs, and combinations thereof.

10. The seat system as recited in claim 9, wherein the internal protrusions have an aspect ratio of greater than 1.

11. The seat system as recited in claim 9, wherein the internal protrusions are the raised dots.

12. The seat system as recited in claim 9, wherein the internal protrusions are the raised rings.

13. The seat system as recited in claim 9, wherein the internal protrusions are the elongated ribs.

14. The seat system as recited in claim 1, wherein the feed channels are embedded in the carrier substrate.

15. The seat system as recited in claim 1, wherein the bladder assembly is in a seat and the feed channel is connected with a pump.

16. The seat system as recited in claim 1, wherein the foldable bladder is on a flap, lateral edges of the flap are severed from the carrier substrate, the foldable bladder is foldable along a fold line, and the associated feed channel crosses the fold line.

17. The seat system as recited in claim 16, wherein the foldable bladder comprises a fastener securing the foldable bladder to the carrier substrate in the folded position, and the fastener includes a snap.

18. The seat system as recited in claim 17, wherein the feed channel includes internal protrusions selected from the group consisting of raised dots, raised rings, elongated ribs, and combinations thereof.

19. A method comprising:
on a bladder assembly comprising a carrier substrate and inflatable bladders attached with the carrier substrate, each of the inflatable bladders fluidly connected with an associated feed channel, the carrier substrate comprising at least one group of configurable bladder locations, and at least one of the inflatable bladders is a foldable bladder, folding the foldable bladder from an unfolded position into a folded position selected from the group of configurable bladder locations; and
securing the foldable bladder in the folded position to the carrier substrate.

20. The method as recited in claim 19, wherein the folding is conducted along a fold line, and the feed channel crosses the fold line.
